(19) United States
(12) Patent Application Publication
(10) Pub. No.: US 2013/0182333 A1
(43) Pub. Date: Jul. 18, 2013

(54) APPARATUS AND PROCESS FOR PRODUCING PLANO-CONVEX SILICONE-ON-GLASS LENS ARRAYS

(71) Applicants: Matthew Meitl, Durham, NC (US); Rudolph Bukovnik, Chapel Hill, NC (US); Etienne Menard, Voglans (FR); Wolfgang Wagner, Chapel Hill, NC (US); David Kneeburg, Durham, NC (US); Jimmy Mark, Dunn, NC (US)

(72) Inventors: Matthew Meitl, Durham, NC (US); Rudolph Bukovnik, Chapel Hill, NC (US); Etienne Menard, Voglans (FR); Wolfgang Wagner, Chapel Hill, NC (US); David Kneeburg, Durham, NC (US); Jimmy Mark, Dunn, NC (US)

(21) Appl. No.: 13/812,100

(22) PCT Filed: Jul. 21, 2011
(86) PCT No.: PCT/US11/44833

§ 371 Date: Mar. 29, 2013

Related U.S. Application Data
(60) Provisional application No. 61/367,491, filed on Jul. 26, 2010.

(51) Int. Cl. G02B 3/00

(52) U.S. Cl. CPC G02B 3/0031; G02B 3/0056
USPC 359/619; 264/2.5

(57) ABSTRACT

Coating a machined mold with a flowable, hardenable polymer coating produces an optically-smooth finish and maintains sharpness in upward-pointing features. These procedures produce molds for highly efficient plano-convex silicone-on-glass lens arrays in a fast and inexpensive manner in which an end-mill defines the shape of a lens, and the coating produces its smoothness. End-mill machining and coating lens-shaped features in plates that have movable pins produce molds with eject features disposed inside features that form templates for lens elements without significantly reducing optical performance. Additionally, machining and coating plates that have movable inserts produce molds for lens arrays with reduced volume and one or several rings in each lens element.

### CLAIM OF PRIORITY

The present application claims priority from U.S. Provisional Patent Application No. 61/367,491 entitled “Apparatus and Process for Producing Plano-Convex Silicone-On-Glass Lens Array,” filed with the United States Patent and Trademark Office on Jul. 26, 2010, the disclosure of which is incorporated by reference herein in its entirety.

### FIELD OF THE INVENTION

This invention generally relates to optical elements, such as optical elements of concentrator photovoltaic modules used for solar power generation. More specifically, the invention pertains to producing arrays of lenses, such as concentrating lenses for concentrator photovoltaics and related methods and apparatus.

### BACKGROUND OF THE INVENTION

Green technologies are becoming increasingly important and are already in high demand. In meeting that demand, the use of solar power generation has substantially increased. Currently, there are many types of photovoltaic devices and solar energy harvesting receiver modules that are formed into solar arrays for generating electric power.

To gain higher output and efficiency from solar arrays, concentrator optics may be used to concentrate the solar energy falling on the solar arrays. The resultant concentrator photovoltaic (CPV) arrays have substantial performance gains. However, with the increasing use of concentrator optics in CPV systems, several challenges have emerged with regard to economically producing high efficiency concentrating lens arrays that also have controllable spatial positioning capabilities. The aforementioned challenges may affect the viability of current CPV applications, as well as manufacturers, sellers, and buyers of solar-based power generation systems. How well these challenges are met will potentially impact the choice of solar-based power generation systems over other power generation approaches.

Past solutions have not completely addressed all of these challenges. For example, arrays of Fresnel lenses, molded in silicone against a glass plate as a lens array, may be used in CPV systems. The individual Fresnel lenses in such arrays typically exhibit lower optical transmission/efficiency as compared to purely convex concentrating lenses. Accordingly, the use of Fresnel lens arrays can result in less than optimal performance for concentrator photovoltaic modules. In addition, the templates used for molding the Fresnel lens arrays can be produced by diamond turning, a precise but expensive and slow process by which the concentric grooves of the Fresnel lenses are defined. In light of the above, the production of high-quality Fresnel lens arrays for concentrator photovoltaic modules (in particular, for prototyping and low-volume production) is often prohibitive in cost and delivery schedules. Additionally, the diamond turned templates are typically tiled together to produce a template for the array, thereby potentially introducing imperfections at the intersections and boundaries between individual Fresnel lenses of the resulting arrays and/or poor spatial control of the positions of the individual lenses. Such imperfections can further reduce the optical efficiency of the Fresnel lens array.

### SUMMARY OF THE INVENTION

It should be appreciated that this Summary is provided to introduce a selection of concepts in a simplified form, the concepts being further described below in the Detailed Description. This Summary is not intended to identify key features or essential features of this disclosure, nor is it intended to limit the scope of the disclosure.

Methods of fabricating a lens array according to some embodiments of the invention include forming a mold having an array of concave-shaped recesses therein and then coating the mold and recesses with a coating material. This coating material, which may be an organic polymer such as an uncured epoxy, is provided in order to reduce a surface roughness of the concave-shaped recesses. A layer of optically transparent material is at least partially filled or otherwise provided in the array of concave-shaped recesses to thereby define an array of plano-convex lenses. The array of plano-convex lenses is then removed from the mold.

In some embodiments, the coating material may define a shape of cusped or peaked ridges at respective boundaries between adjacent ones of the concave-shaped recesses. For example, the mold may define the peaked ridges at the respective boundaries between the adjacent ones of the concave-shaped recesses, and the coating material may be configured to conform to the shape of the peaked ridges at the respective boundaries. A distance between the boundaries of the adjacent ones of the concave-shaped recesses may be about 20 microns or less, or even less than about 12.5 microns in some embodiments. According to some of embodiments of the invention, the step of forming the mold may include milling an array of concave-shaped recesses into a support substrate and the step of coating may include spraying the array of concave-shaped recesses with the coating material. The milling step may include plunge-cutting the support substrate using an end mill having a cross-section substantially similar in shape to that of a plano-convex lens of the array. The spraying step may be followed by a step of curing the coating material to define the shape of the peaked ridges therein. According to still further embodiments of the invention, the step of removing the array of plano-convex lenses may include injecting a substance (e.g., pressurized gas, liquid, etc.) between the layer of optically transparent material and the mold to thereby reduce a degree of adhesion between the coating material and the layer of optically transparent material.

According to still further embodiments of the invention, the step of at least partially filling the recesses may be preceded by a step of attaching an optically transparent plate (e.g., glass) to the mold. The filling step may then include injecting the optically transparent material (e.g., silicone) into a space between the optically transparent plate and the coating material covering the array of concave-shaped recesses. The optically transparent plate may be treated (e.g., chemically treated) so that a degree of adhesion between an inner surface of the optically transparent plate and the optically transparent material is greater than a degree of adhesion between the optically transparent material and the coating material. According to some additional embodiments of the invention, the support substrate is made of metal and the step of forming the concave-shaped recesses includes milling concave-shaped recesses into the metal.

According to yet further embodiments of the invention, the mold may be formed from a support substrate having a plurality of pins therein, which are removable from a backside of the support substrate. The step of milling an array of concave-shaped recesses into the support substrate may also include milling the plurality of pins to thereby define concave-shaped pins adjacent bottoms of the concave-shaped recesses. The removing step may also include at least partially moving the concave-shaped pins away from the optically transparent material in order to facilitate the injection of pressurized gas or fluid into a space between the layer of optically transparent material and the mold, or moving the concave-shaped pins toward the optically transparent material to eject the array from the mold.

In additional embodiments of the invention, the mold may be formed as a support substrate having a plurality of movable inserts therein that extends to a backside of the support substrate. Then, during a milling operation, a front side of the support substrate and front sides of the plurality of movable inserts are patterned to define an array of concave-shaped recesses in the mold, which have concave-shaped movable inserts adjacent bottoms thereof. Based on these embodiments, the coating step may include covering the concave-shaped movable inserts with the coating material. The at least partially filling step may also be preceded by depressing or pulling the movable inserts into or out of the support substrate (e.g., moving the inserts toward or away from the optically transparent plate) to thereby raise or lower the front sides of the movable inserts relative to the concave-shaped recesses. This step of depressing the movable inserts has the advantage of reducing an amount of optically transparent material needed to at least partially fill the concave-shaped recesses. These steps of using movable inserts may yield a two-dimensional array of convex lenses having respective recesses therein with convex-shaped bottoms. Each of these recesses may be aligned to a center of a respective convex lens in the two-dimensional array. In the event that multiple movable inserts are used with each of the concave-shaped recesses, then each of the convex lenses may include multiple respective ring-shaped recesses therein having a convex-shaped bottom.

Methods of fabricating a lens array according to further embodiments of the present invention include forming a mold having a densely-packed array of concave-shaped recesses therein and cusped ridges between adjacent recesses. The mold is coated with a liquid coating material that is configured to reduce a surface roughness of the concave-shaped recesses. The liquid coating material is also configured to conform to a shape of the cusped ridges. The liquid coating material is hardened on the mold with a force of gravity pointing opposite the cusped ridges. The hardening of the liquid coating material may define the shape of the cusped ridges therein. The array of concave-shaped recesses is at least partially filled with a layer of optically transparent silicone to thereby define an array of plano-convex lenses, and the array of plano-convex lenses is removed from the mold.

A plano-convex lens array according to some embodiments of the present invention includes an optically transparent silicone layer defining a two-dimensional array of convex lenses. In some embodiments, respective boundaries of adjacent ones of the convex lenses are separated by about 20 microns or less. This distance between adjacent lenses may be achieved using molds having a coating material thereon that defines a shape of cusped or peaked ridges at the respective boundaries between the adjacent lenses. In some embodiments, the respective boundaries between adjacent ones of the convex lenses may be separated by less than about 12.5 microns.

Other methods and/or devices according to some embodiments will become apparent to one with skill in the art upon review of the following drawings and detailed description. It is intended that all such additional embodiments, in addition to any and all combinations of the above embodiments, be included within this description, be within the scope of the invention, and be protected by the accompanying claims.

### BRIEF DESCRIPTION OF THE DRAWINGS

FIG. 1 is a flow chart that describes a process for making plano-convex (PCX) silicone-on-glass (SOG) lens arrays according to some embodiments of the invention.

FIG. 2 is a drawing of an unfinished mold that includes machined features for molding lens elements, according to some embodiments of the invention.

FIG. 3 is a photograph of two end mills suitable for machining a mold by plunge-cutting, according to some embodiments of the invention.

FIGS. 4A-C illustrate sharp, cusp-like boundaries between machined features in a mold according to some embodiments of the invention with Scanning Electron Microscopy (SEM) images (FIGS. 4A and 4B) and a drawing (FIG. 4C).

FIG. 5 depicts the optically smooth surface produced on a machined mold by a coating process according to some embodiments of the invention.

FIGS. 6A-B illustrate how a coating process can maintain sharpness of the cusp-like boundaries between machined features in a mold, according to some embodiments of the invention.

FIG. 7 is a drawing of a mold that includes a movable eject feature to facilitate the separation of a finished lens from a mold, according to some embodiments of the invention.

FIG. 8 is a photograph of a mold highlighting the sharp, cusp-like boundaries between features of the mold, according to some embodiments of the invention.

FIGS. 9A-B show two additional photographs of a mold joined to a plate of glass for the production of a lens array on that plate, according to some embodiments of the invention.

FIG. 10 is a photograph of a lens array produced by a method according to some embodiments of the invention.

FIG. 11 is a photograph of a mold and a lens array produced by the mold, according to some embodiments of the invention.

FIG. 12 is another photograph of a mold and a lens array produced by the mold, according to some embodiments of the invention. The photograph was taken prior to separation of the lens array from the mold.

FIG. 13 is a flow chart that describes a process for making lens arrays with reduced volume using movable inserts, according to some embodiments of the invention.

FIG. 14 depicts two steps (machining holes in a plate and machining movable inserts) of a process for making a mold for lens arrays with single-ring lens elements, according to some embodiments of the invention.

FIGS. 15A-B depict two subsequent steps (fitting movable inserts into holes in a plate and machining the resulting assembly) of a process for making a mold for lens arrays with single-ring lens elements according to some embodiments of the invention.

FIGS. 16A-B depict two further steps (coating the machined plate-insert assembly with a hardenable polymer coating and moving the inserts to produce sharply defined rings) of a process for making a mold for lens arrays with single-ring lens elements according to embodiments of the invention.

FIGS. 17A-B depict additional steps (coating the machined plate-insert-sub-insert assembly with a hardenable polymer coating and moving the inserts to produce sharply-defined rings) of a process for making a mold for lens arrays with few-ring lens elements in which movable sub-inserts fit into holes in the movable inserts according to embodiments of the invention.

FIGS. 18A-D depict portions of four types molds produced according to some embodiments of the invention with respect to the use of movable inserts, including no inserts (FIG. 18A), a single concentric insert (FIG. 18B), two concentric inserts/sub-inserts (FIG. 18C), and a combination of concentric and non-concentric inserts (FIG. 18D).

### DETAILED DESCRIPTION OF EMBODIMENTS OF THE INVENTION

Some embodiments of the present invention arise from discoveries made in attempts to realize an economical process for fabricating lens arrays for concentrator photovoltaic devices, whereby the lens arrays produced can have high optical efficiencies of above 80% and provide good control of spatial positioning of the lens elements within the array. These discoveries led to methods and apparatus of the invention described herein for producing plano-convex lens arrays for photovoltaics using low-cost manufacturing processes. Embodiments of the invention allow the production of a template/master using commonly available, high throughput machining tools and a surface finishing process that produces optically smooth surfaces and sharp boundaries between lens elements. The template/master is then used to mold silicone against glass plates, thereby producing highly efficient/transmissive, lens arrays for concentrator photovoltaics at low cost.

Accordingly, embodiments of the present invention provide a lens array for concentrator photovoltaics that can be produced economically, feature good control of the spatial positioning of the individual lenses of the array and have high optical efficiency to transmit a high percentage (>80%, preferably >85%, even more preferably 90% or more) of incident sunlight onto the array of receivers.

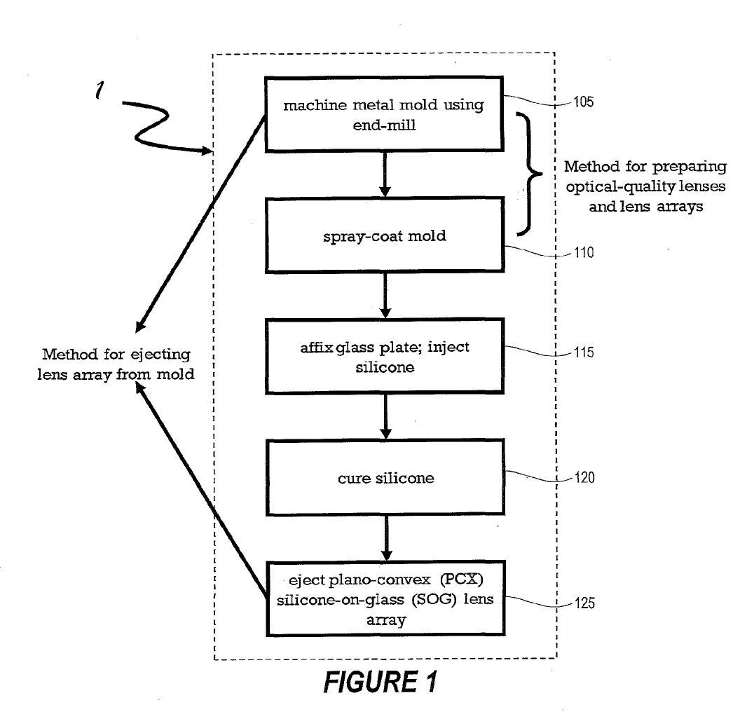

Embodiments of the invention are described in greater detail below with reference to FIGS. 1 through 17.

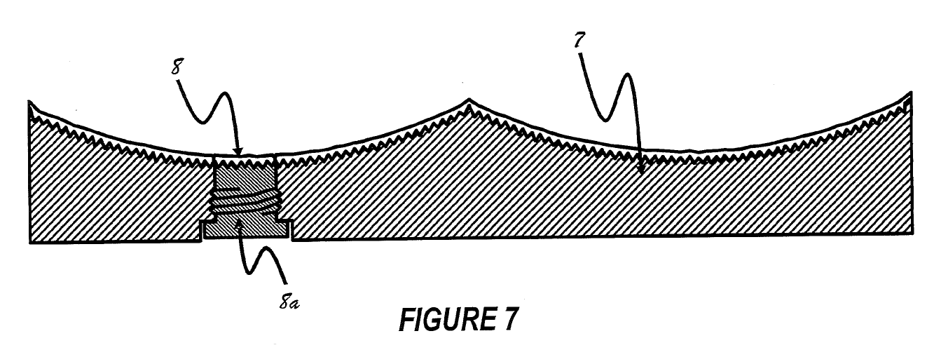

FIG. 1 is a flow chart that describes a process 1 for making plano-convex (PCX) silicone-on-glass (SOG) lens arrays in accordance with embodiments of the present invention. An end mill is used to machine an array of features that have the shape of a lens element into a piece of material (e.g., a machineable metal), to form a mold (block 105). The mold is coated with a flowable, hardenable polymer material (e.g., by spray coating), thereby producing an optically smooth surface, (i.e., a surface with smoothness such that a lens element cast from the surface has good optical efficiency), on at least a portion of the mold (block 110). After application and hardening of the polymer coating, a glass plate is affixed to the mold (block 115). The surface of the glass plate is optionally treated to improve adhesion between the glass plate and the moldable lens material (silicone). Examples of such surface treatment processes include the application of silane-based molecular coupling agents, plasma treatments, ammonium hydroxide-hydrogen peroxide-water mixtures, high-pressure dilute ammonium hydroxide sprays, and/or ultra- or megasonically-energized dilute ammonium hydroxide or tetramethylammonium hydroxide solutions. The lens-shaped features between the machined, coated mold and the glass plate are injected with or otherwise at least partially filled by uncured silicone fluid (block 115). Heating, the progression of time, and/or other stimuli (e.g. ultra-violet electromagnetic radiation exposure) are used to cure the silicone in the shape of the features of the mold (block 120), and the finished lens array is separated from the mold by an ejection process (block 125). Reduced adhesion between the silicone and the hardened polymer coating or other coatings, along with ejection features (fluid-assisted or push pins, as presented in FIG. 7) facilitate the separation of the finished lens array from the mold.

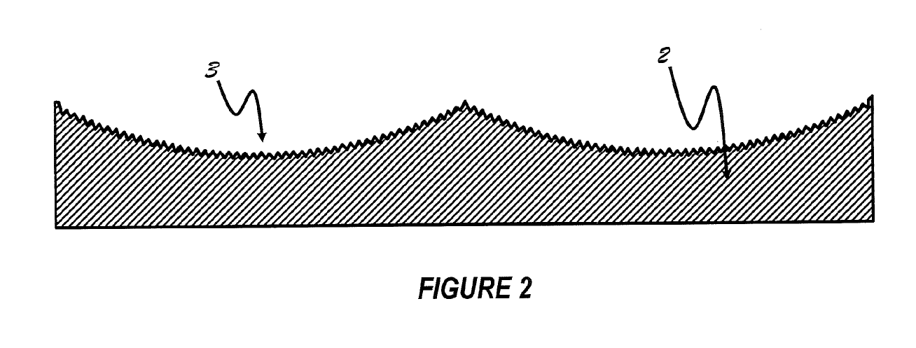

FIG. 2 is a cross-sectional view illustrating an unfinished mold 2 according to some embodiments of the invention that includes machined features 3 for molding lens elements. Machining using an end-mill forms the unfinished mold 2 from plates or other support substrates composed of machineable materials such as aluminum alloys, copper alloys, and/or stainless steels. In some embodiments, the machined features or recesses 3 are produced by selecting a suitably-shaped end mill and plunging the rotating end-mill into the machineable plate at a plurality of sites, thereby generating an array of features for molding lens elements. This approach can produce molds having concave recesses or features 3 that are precisely and accurately aligned, spatially, to within about 25 microns (or micrometers) or even about 12.5 microns of their intended position and relative to each other due to the capabilities of available machining tools and the ability to form each feature without re-staging the work. This alignment accuracy is desirable for applications in concentrator photovoltaics, specifically for producing lens arrays with individual lens elements with a uniform aperture area and a well-defined spatial distribution.

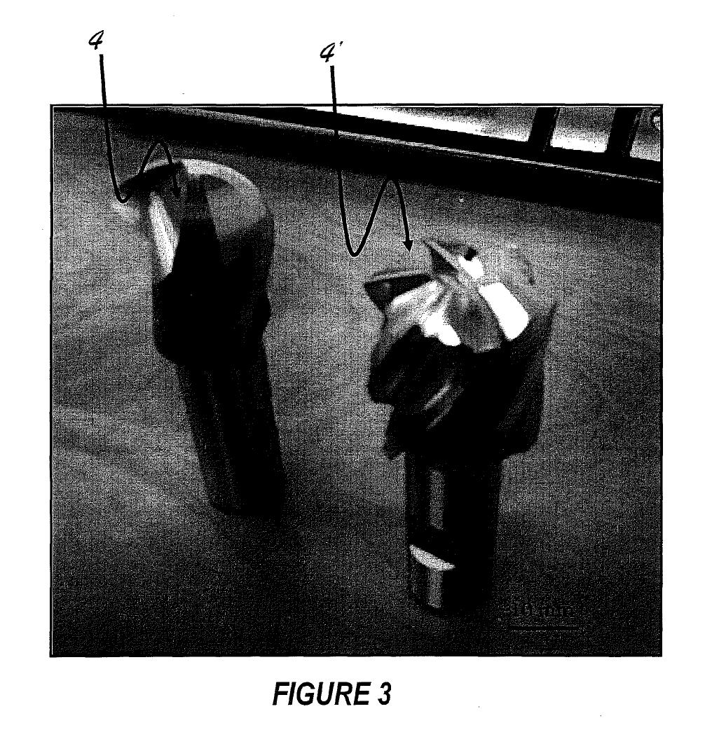

FIG. 3 shows two end-mills 4 and 4′ suitable for plunge-cut machining of the molds to coarsely define the lenses therein according to embodiments of the invention. The shape of the crown of the end-mills 4 and/or 4′ may be chosen to match or closely approximate the shape of the lens elements of a molded lens array produced using a mold of the invention. Shapes for the crown of such end-mills 4 and 4′ include spherical and aspheric (e.g. conic) shapes. End-mills suitable for this use include those formed from commercially available hard steel alloys and carbide materials, among other materials.

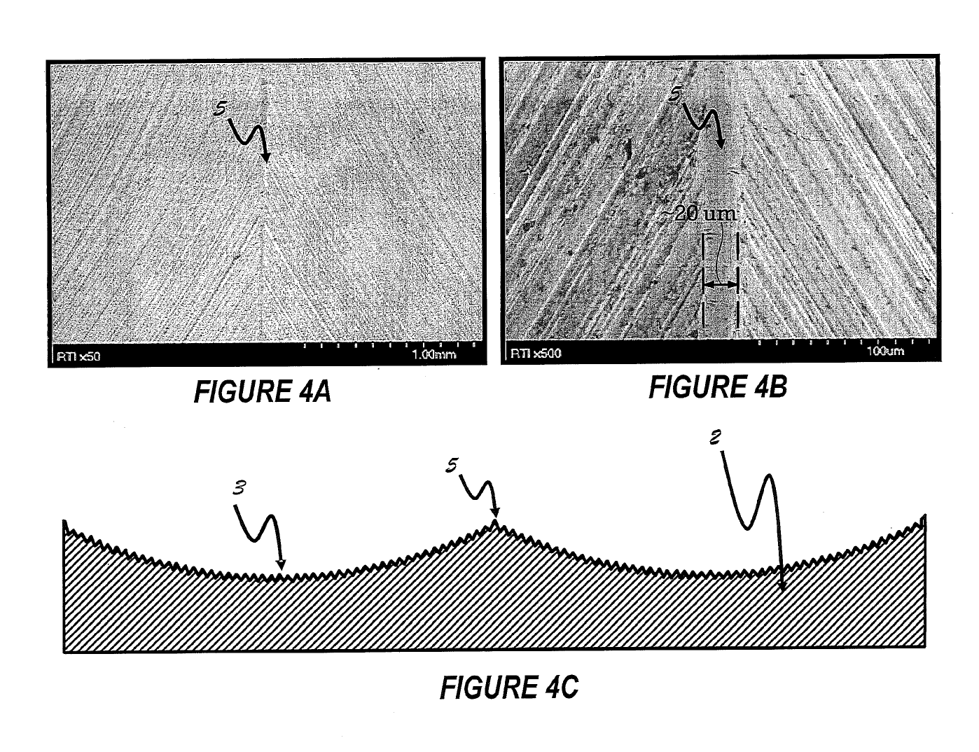

FIGS. 4A-4C illustrate the sharp, cusp-like boundaries or peaked ridges 5 between adjacent ones of the machined features 3 for molding lens elements in the machined mold 2 according to embodiments of the present invention, Roundness, flatness, dullness, or other deviations from the shape of the end-mill in the area surrounding the boundaries 5 between the features 3 may reduce the ability of portions of the resulting molded lens arrays to direct incident light to a concentrator photovoltaic receiver efficiently. The width of the boundary (e.g., the distance between adjacent boundaries 5), therefore, may be defined as narrow as possible in some embodiments. The scanning electron microscope (SEM) images shown in FIGS. 4A and 4B indicate that machining according to embodiments of the present invention with a plunge-cutting end-mill can form relatively sharp boundaries 5 with very narrow (-20 micron) rounded regions surrounding them.

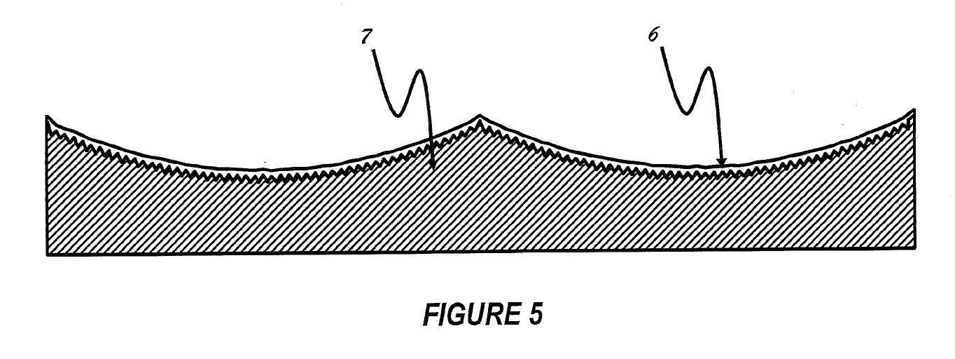

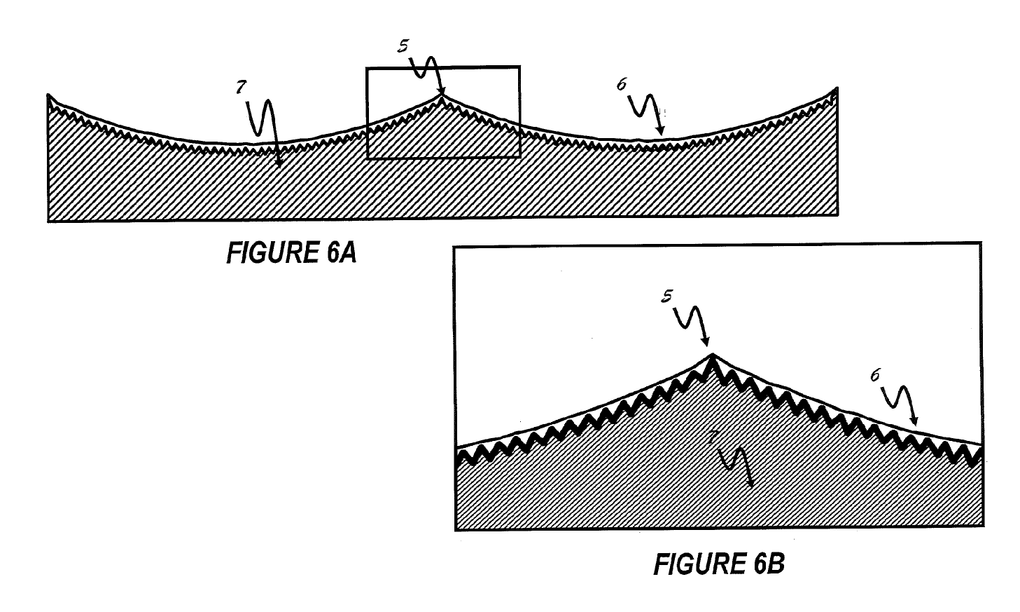

FIGS. 5 and 6A-B illustrate effects of coating the machined mold with a hardenable polymer material in accordance with embodiments of the invention. The machined surface of the mold is rough (as illustrated and imaged in FIGS. 4A-C) with peak-to-valley roughness on the order of a few microns, and is a relatively poor template for the surface of a lens element that might be molded against it. The resulting lens exhibits poor optical efficiency due to scattering and may be incapable of efficiently concentrating sunlight onto a concentrator photovoltaic receiver. Applying a flowable, hardenable polymer coating 6 (for example, by spraying an uncured epoxy solution) that has a thickness roughly equal to or slightly greater than the peak-to-valley roughness of the machined surface 3 can smooth the machined surface 3. The coating 6 can be hardened by heating, the progression of time, evaporation of solvents in the coating, and/or other stimuli (e.g. ultra-violet electromagnetic radiation exposure), and conforms to the underlying shape of the mold to maintain the sharp, cusp-like boundaries or peaks 5 pointing roughly in the opposite direction of the force of gravity, thereby forming a coated, machined mold 7, as shown in the enlarged view of FIG. 6B. The flowable characteristics of the coating 6 allow it to partially or fully cover the roughness of the machined mold surface 7. The force of gravity prevents the flowable coating from reducing the sharpness of the boundaries 5 between the concave features 3. It should be noted that it may be difficult or impossible to reduce the roughness of the feature surfaces without reducing the sharpness of the cusped boundaries or ridges between the features by other known, inexpensive methods, such as polishing. Additionally, the hardened coating 6 can exhibit poor adhesion to silicone, thereby facilitating the release of finished molded lens arrays from the mold 7.

FIG. 7 is a cross-sectional view of a mold 7 according to embodiments of the present invention that includes a movable eject feature 8 to facilitate the separation of a finished lens array from the mold 7. In some embodiments of the present invention, the mold 7 may be machined from a plate that includes a tightly fitting movable pin 8a. The machining process forms machined features 3 for molding a lens element according to the processes described in the paragraphs above and FIGS. 1 through 4 such that the surfaces of at least one of the features 3 includes a portion of the machined surface of the pin 8a, and the entirety of the feature surface is completely or minimally interrupted at the boundary between the pin 8a and the rest of the mold 7. The pin 8a can be disposed near or at the center of a machined feature 3, at the peak of the resulting lens element. Alternatively, the face of the movable pin 8a disposed at the center of a machined feature 3 may be small relative to the size of the lens element and relatively flat. The movable pin 8a can be composed of the same material as the mold 7 or of a similar material, thereby facilitating the machining operation and producing a better, more controlled surface finish. The movable pin 8a and the rest of the mold 7 are coated with a hardenable polymer 6 according to the procedures described above and shown in FIGS. 5 and 6 to generate a smooth surface suitable for lens molding. A movable eject feature can facilitate the separation of a finished lens array from the mold 7 by using the moveable pin 8a in one or more of at least two ways, including operating as a port for fluid-assisted ejection and operating as a push-pin for ejection.

When operating as a port for fluid-assisted ejection, the movable pin 8a is removed or retracted from the rest of the mold 7 after curing the silicone-on-glass lens array, exposing a channel that extends through the mold from the surface of the lens array to the opposing side of the mold 7, and fluid (e.g. air, pressurized air, nitrogen gas, other gases, ethylene glycol, water, or other liquids) is injected through that channel and flows between the mold 7 and the lens array, thereby separating the two. For a fluid-assist ejection feature, the moveable pin 8a can be disposed at or near the center of the recess 3 in the mold 7, such that the injected fluid front separates a large portion of the interface between the mold 7 and lens array before reaching an edge of the array.

When operating as a push-pin, the moveable pin 8a moves toward the lens array, thereby applying a force that works to separate the lens array from the rest of the mold 7. It should be noted that some push-pin eject features that are known in the art (i.e., eject features that are not machined or coated according to embodiments of the present invention) are typically disposed at or near the perimeter of the mold such that they apply force to the perimeter or the area near the perimeter of the finished lens array or glass plate. Ejectors such as these can be detrimental if disposed in the areas occupied by features for molding lens elements (i.e. the central region of the mold) because they can interrupt the light-collecting surfaces of the resulting lens arrays, thereby reducing optical efficiency. In contrast, eject features according to embodiments of the present invention do not interrupt the light-collecting surfaces of resulting lens arrays and therefore may be disposed inside the features 3 for molding lens elements without significantly reducing their optical efficiency. The eject features according to embodiments of the present invention (e.g., disposed at or near the center of the mold to provide fluid and/or push-pin ejection) can also be combined with ejectors known in the art at or near the perimeter of the mold to facilitate the separation of finished lens arrays from the mold 7 of the present invention.

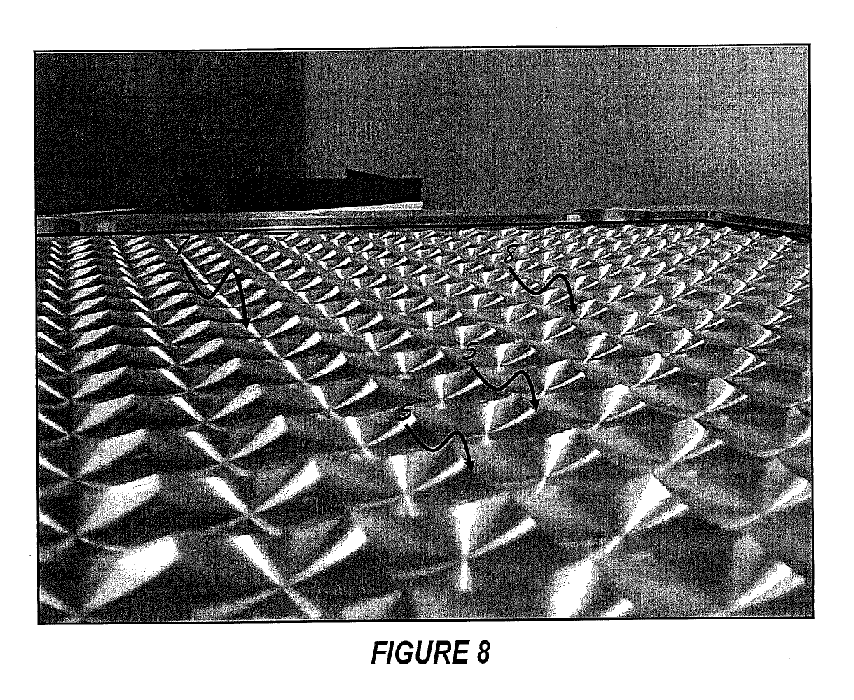

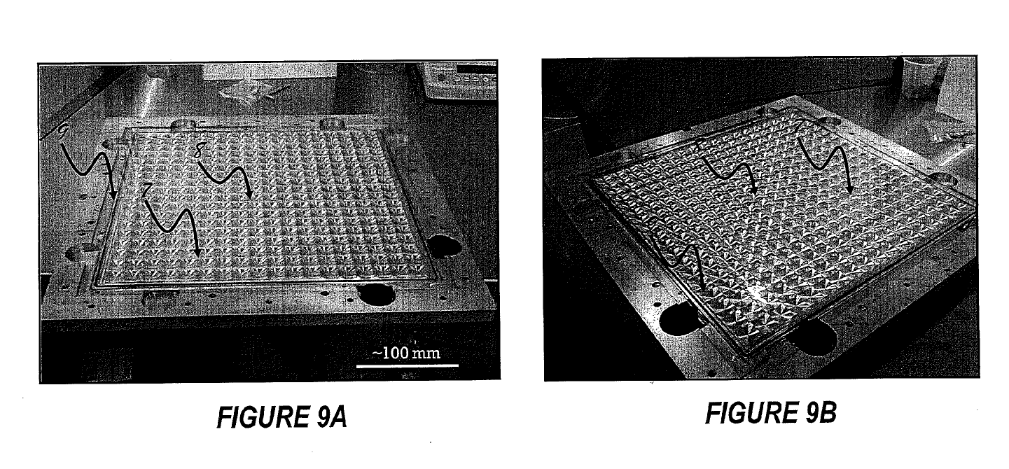

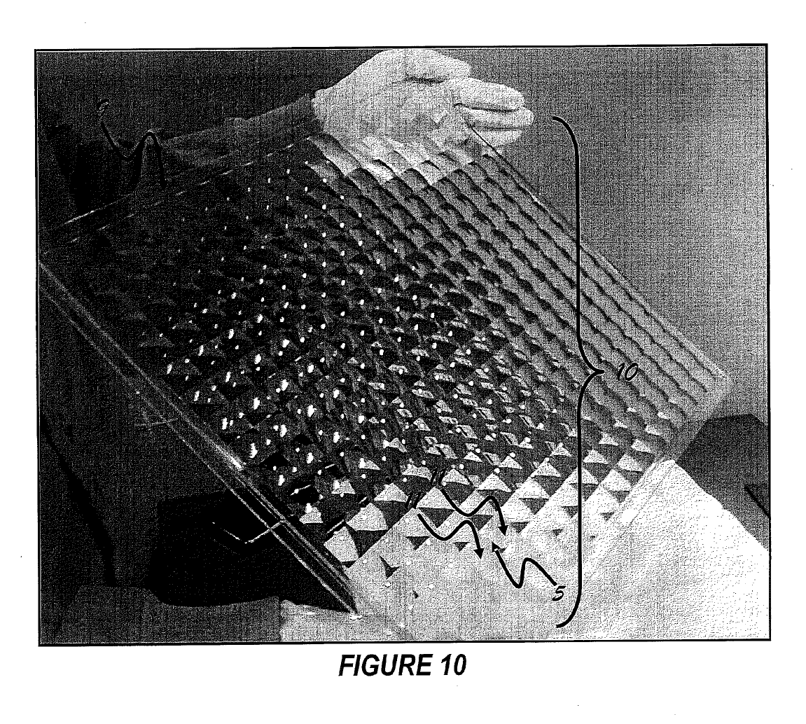

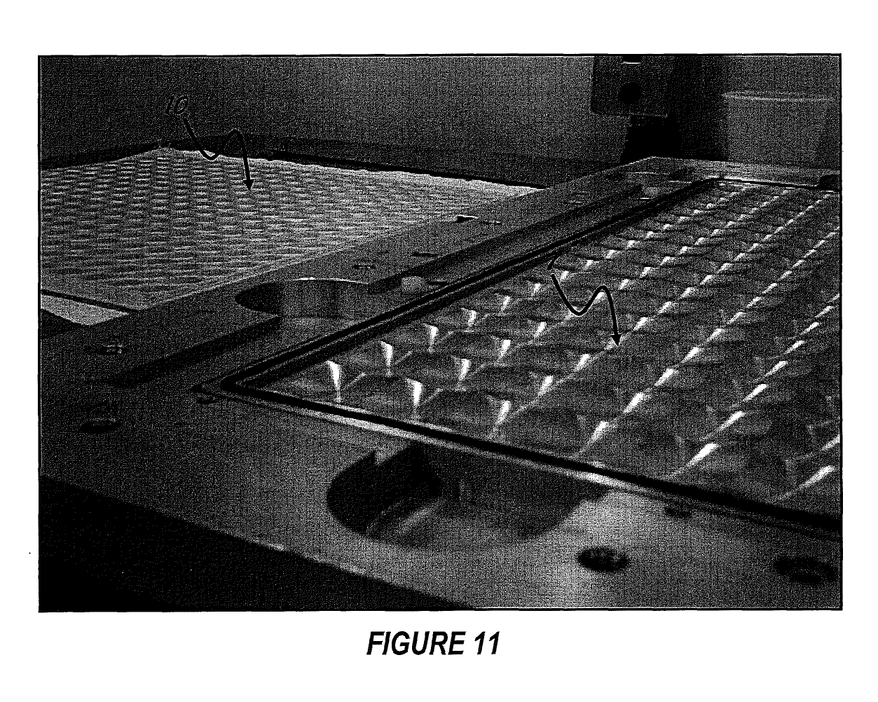

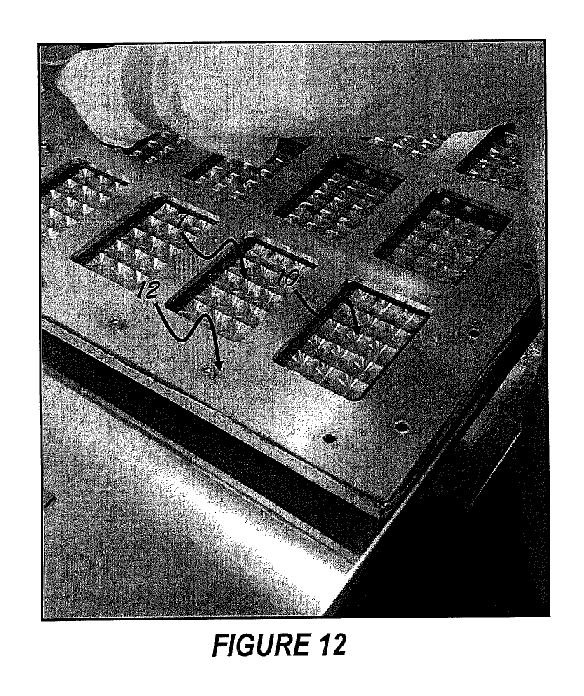

FIGS. 8 through 12 are photographs illustrating examples of molds and lens arrays made in accordance with embodiments of the present invention. FIG. 8 shows a finished, coated, machined mold 7 of the present invention that is produced using the procedures described herein. The image highlights the sharp, cusped or peaked boundaries 5 between the features or recesses 3 for molding individual lens elements. The mold 7 in this image includes an eject feature 8 described in the paragraphs above and shown in FIG. 7, but the feature is difficult to distinguish because it is composed of the same material as the rest of the plate (here, an aluminum alloy) in this embodiment. FIGS. 9A-B show two additional photographs of a mold 7 in accordance with embodiments the present invention joined to a (transparent) plate of glass 9. The glass plate 9, the mold 7, and a fluoroelastomer o-ring disposed between the two near their perimeters define a space or cavity that is at least partially filled with silicone that is subsequently cured to form, along with the glass plate, the finished lens array. FIG. 10 is a photograph of a finished lens array 10 according to embodiments of the present invention supported by a glass plate 9 and produced using the processes described herein. The lens array 10 is formed from the silicone material and includes more than three hundred molded lens elements 11, each having respective cusped boundaries 5 therebetween. FIG. 11 is a photograph that shows both the coated, machined mold 7 according to embodiments of the present invention and a finished lens array 10 that was produced from the mold 7. FIG. 12 shows a metal plate 12 that presses the glass plate 9 against the o-ring disposed between it and the machined and coated mold 7 to produce the finished lens array 10 from the silicone material injected into the space defined between the glass plate and the mold 7. In this photograph, the metal plate 12 is being removed to allow separation of the finished lens array 10 from the mold 7.

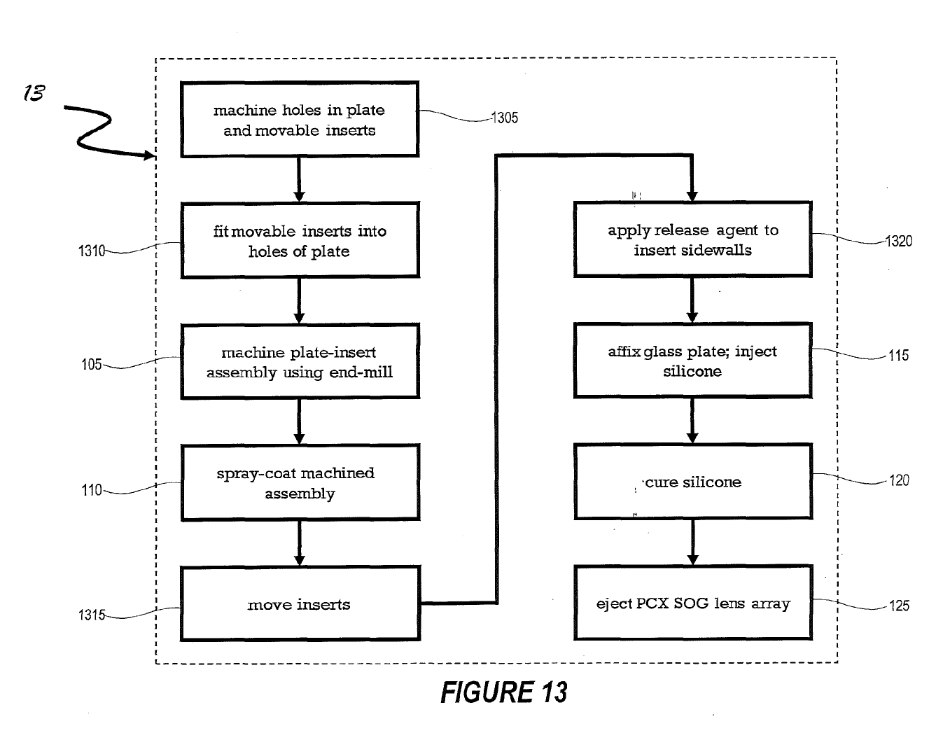

FIG. 13 is a flowchart that describes a process for making lens arrays according to embodiments of the present invention with reduced volume using movable inserts. This process 13 includes the steps 105-125 of the flowchart shown in FIG. 1, with additional steps to reduce the volume of the features for molding lens elements in the mold. As shown in FIG. 13 holes are machined in a plate (block 1305) and movable inserts are provided to fit into the holes in the plate (block 1310). The perimeter of the holes in the plate and the perimeter of the moveable inserts forms a “ring” that may be circular, rectangular, hexagonal, or of some other shape. Optionally, each insert may include another machined hole into which a sub-insert is placed, thereby forming two “rings” in each feature for molding a lens element. The inserts should fit tightly into the machined holes, and thermal expansion and/or shrinkage can be used to facilitate the insertion process. The plate-insert assembly is machined using an end-mill (block 105) to produce features for molding lens elements that are similar to the machined features 3 shown in FIG. 2, but that include as a portion of their surfaces a curved, machined surface of the movable inserts, such as the moveable pin 8a shown in FIG. 7. A flowable, hardenable polymer coating is coated the surface of the machined assembly, e.g. by spraying (block 110), in a manner similar to that described above and shown in FIGS. 5 and 6. The movable inserts are moved to reduce the volume of the features for molding lens elements (block 1315). In some embodiments, thermal expansion and/or shrinkage may be used to facilitate the moving process. A highly-conformal release layer (e.g. parylene) or other release agent is coated on the mold (block 1320) to reduce adhesion to the sidewalls of the moved inserts and/or holes in the plate that are not coated by the flowable, hardenable polymer coating. The process then proceeds in a manner similar to that shown in FIG. 1. In particular, a glass plate is affixed to the mold, and uncured silicone fluid is injected to subsequently partially or completely fill the reduced-volume, lens-shaped features between the machined, coated mold and the glass plate (block 115). Heating, the progression of time, and/or other stimuli (e.g. ultra-violet electromagnetic radiation exposure) are used cure the silicone in the shape of the features of the mold (block 120), and the finished lens array is separated from the mold by an ejection process (block 125).

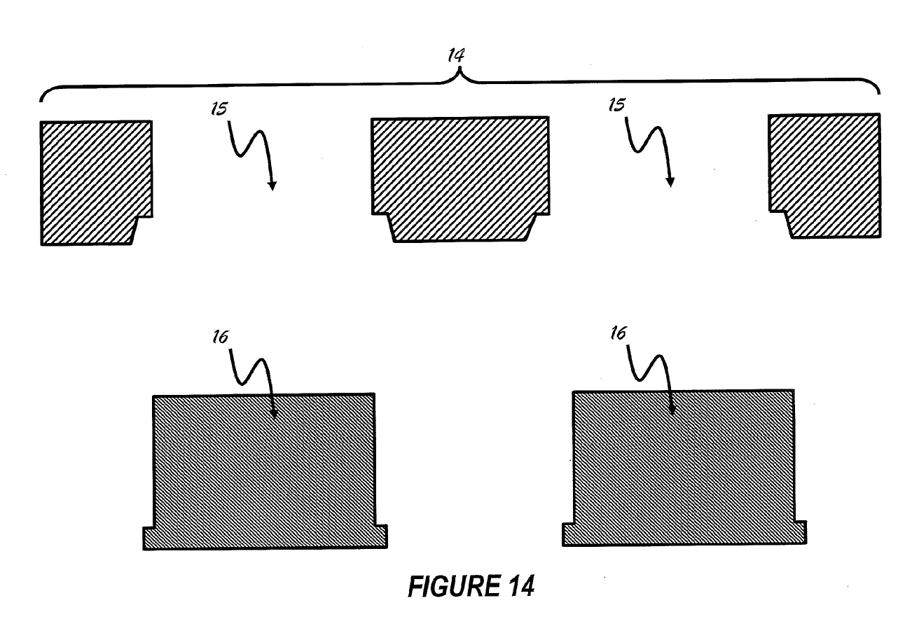

FIG. 14 illustrates initial steps of a process for producing molds in accordance with embodiments of the present invention that include a single ring in each element. A machining technique (e.g. using an end mill) forms plurality of holes 15 in a plate 14 used for the mold, with each hole disposed in the desired position of each feature for molding a lens element. Another machining technique (e.g. using a lathe, precision grinding, diamond turning, or an end mill) produces inserts 16 with shapes that closely match the holes 15 in the machined plate 14.

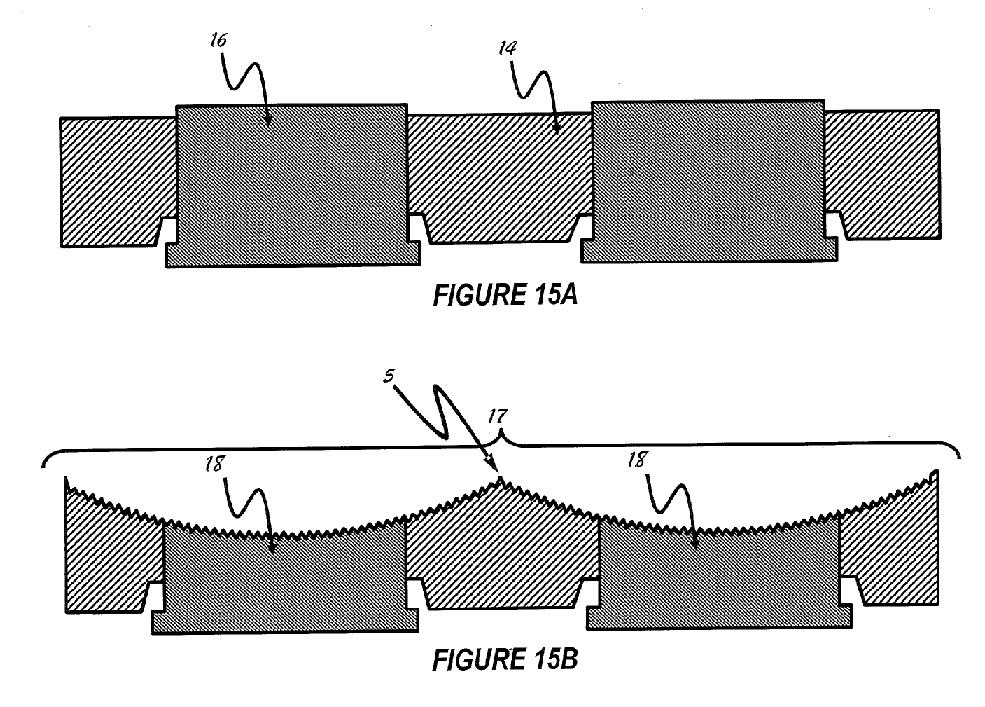

FIGS. 15A-B illustrate two subsequent steps of the process for producing molds in accordance with embodiments of the present invention that have a single ring in each element. As shown in FIG. 15A, the machined inserts 16 are inserted into the plate 14 including the machined holes 15. The inserts 16 should fit tightly into the machined holes 15, and thermal expansion and/or shrinkage may be used to facilitate the insertion process in some embodiments. The inserts 16 and plate 14 form an assembly 17 which is then machined, as shown in FIG. 15B, using an end-mill by the process described in FIGS. 2 through 4. The machined surfaces of the inserts 18 and the plate 14 define features or recesses 3 that each forms a continuous, concave-shaped contour. The shape of the contour and the shape of the end-mills used should be designed with consideration that the inserts 16 will be raised or recessed to define the shape of the lens elements. The capabilities of available machining tools and the ability to machine the assembly without re-staging can produce machined assemblies 17 that have features spatially arranged to within about 25 microns of their intended positions or better.

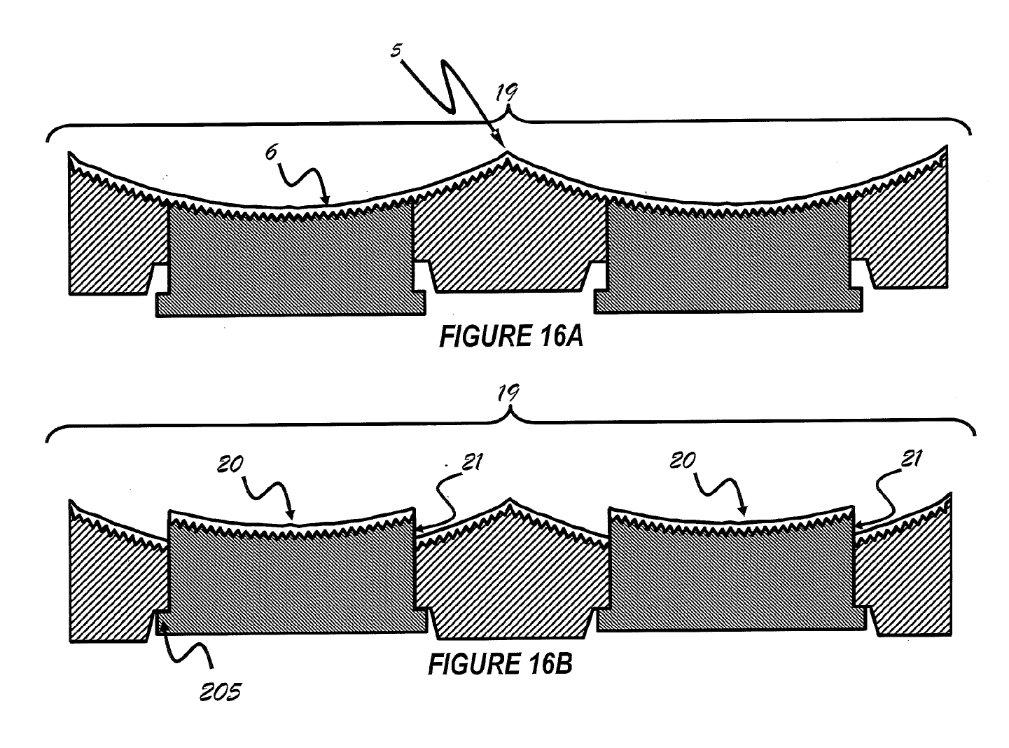

FIGS. 16A-B illustrate two further steps of the process for producing molds in accordance with embodiments of the present invention that have a single ring in each element. The plate-insert assembly 17 with machined contours 3 is coated with a hardenable polymer 6 as shown in FIGS. 5 and 6. This produces a surface on the coated assembly 19 that is sufficiently smooth for efficient lensing in the resulting molded lenses while maintaining the shape of the sharp, cusp-like or peaked boundaries 5 between adjacent features 3, as shown in FIG. 16A. After the coating 6 is hardened, the inserts are moved 20 to reduce the volume of the features 3 for molding lens elements, as shown in FIG. 16B. Thermal expansion or contraction or other means may be used for facilitating the moving process 20. The moving process and the extent of movement may be facilitated and controlled by mechanical reference features 205 of the inserts 16 in some embodiments. However, in other embodiments, the moving process and the extent of movement may be facilitated and controlled by other means that do not require that the inserts 16 have mechanical reference features 205, for example, by using an reference apparatus external to the mold or by precision motion control techniques.

The raising process 20 produces a ring boundary 21 that is relatively sharp due to the close fit of the inserts 16 into the holes 15 in the plate 14. The sharpness or severity of the transition between the raised inserts 20 and the surface of the features 3 in the plate 14, which is defined by the ring boundary 21, can produce lens elements with high optical efficiency because roundness, flatness, dullness, or other deviation from the general curvature of the end-mill in the area surrounding the ring boundary 21 may reduce the ability of portions of the resulting molded lens element to direct incident light to a concentrator photovoltaic receiver efficiently. Coating the assembly 17 with the layer 6 before moving the inserts 18 maintains sharpness and prevents pooling of the flowable material 6 in the base of the ring boundary 21. The raising process 20 also exposes a portion of the sidewalls of the movable inserts 16 and/or holes in the plate 15 that is not covered by the flowable, hardenable polymer coating 6. In some embodiments, the exposed portions of the sidewalls are subsequently coated by a thin, highly-conformal release layer (e.g. parylene, not shown) to avoid strong adhesion between the exposed portion of the sidewalls and silicone of the molded lens arrays. The release layer should be thin enough and conformal enough to maintain or not significantly reduce the sharpness of the ring boundaries and the boundaries between lens elements for the reasons described above. The processes described for producing molds in accordance with embodiments of the present invention that have a single ring in each element may be include the eject features as described herein and illustrated in FIG. 7, alone or in combination with ejectors known in the art.

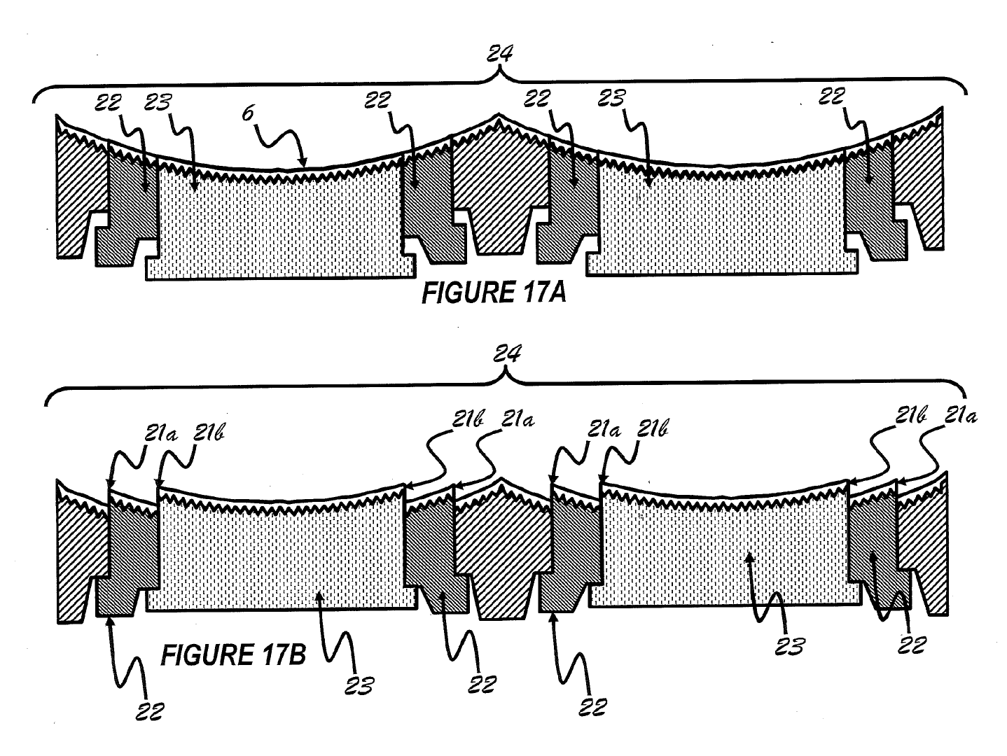

FIGS. 17A-B illustrate two steps of a process for producing molds in accordance with further embodiments of the present invention that have two rings in each insert element. Holes are machined in a plate 14, movable inserts 22 having shapes that closely match the holes in the plate 14 and including a machined hole disposed through the center of each insert 22 are provided, and sub-inserts 23 having shapes that closely match the holes in the inserts 22 are provided. The sub-inserts 23 are placed into holes in the inserts 22, and the inserts 22 are placed in the holes of the plate 14, each object fitting tightly. In some embodiments, thermal expansion and/or shrinkage may be used to facilitate fitting. The resulting plate-insert/sub-insert assembly is machined using an end-mill by a process similar to that described with reference to FIGS. 2 through 4 and 15 and coated by a process similar to that described with reference to FIGS. 5, 6, and 16 thereby producing the coated, machined plate-insert/sub-insert assembly 24 shown in FIG. 17A. As shown in FIG. 17B, the inserts 22 and sub-inserts 23 are raised to reduce the volume of the features for molding lens elements, producing two sharp ring boundaries 21a and 21b in each feature 3 and exposing a portion of the sidewalls of the insert 22 and sub-inserts 23. The sharpness or severity of the transitions between the raised inserts 22 and sub-inserts 23 and the surface of the features 3 in the plate 14 provide abrupt discontinuities 21a and 21b in the surface of the features 3, which can produce lens elements with good optical efficiency and reduced volume. Thermal expansion, shrinkage, and/or other means may be used to facilitate the movement of the insert and sub-insert. Coating the assembly with the hardenable polymer 6 before moving the inserts 22 and/or sub-inserts 23 can avoid pooling of the flowable material 6 in the base of the ring boundaries 21a and/or 21b. A thin, highly-conformal release layer (e.g. parylene, not shown) can also be applied after the inserts 22 and sub-inserts 23 are raised to avoid strong adhesion between the exposed portion of the sidewalls of the inserts 22 and sub-inserts 23 and the silicone of the molded lens arrays, which subsequently fills the assembly 24 once the inserts 22 and sub-inserts 23 have been moved.

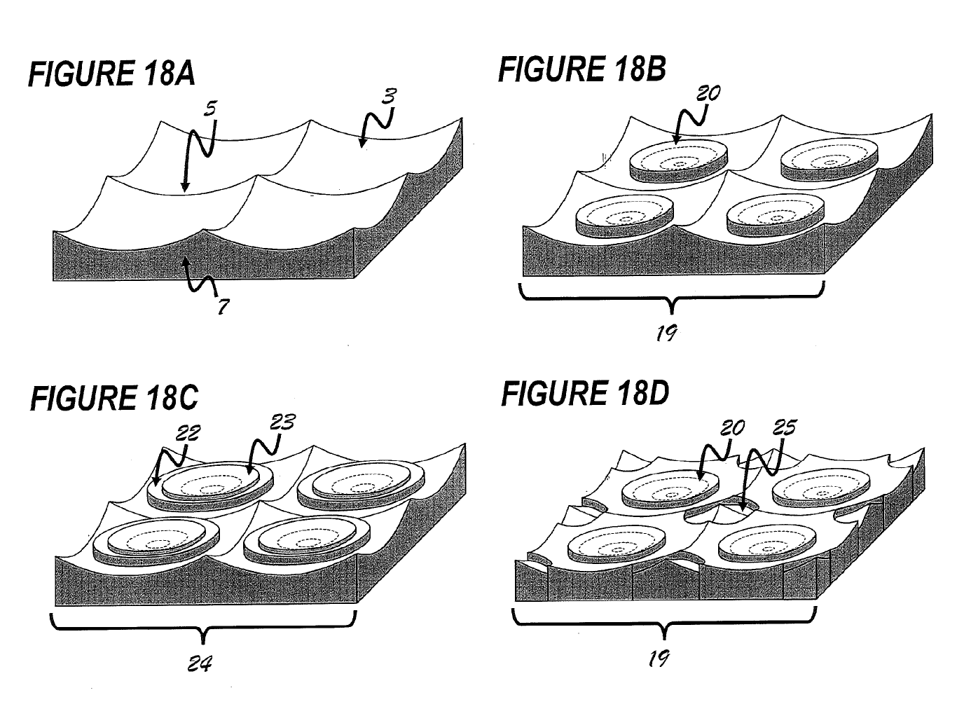

FIGS. 18A-D illustrate four types of molds produced by some embodiments of the present invention with respect to the use of movable inserts. FIG. 18A illustrates a portion of mold without movable inserts produced using the methods described in FIGS. 2, 5, and 6. FIG. 18B illustrates a portion of a mold with movable inserts 20 produced using the methods described in FIGS. 13-16 with the surface of the movable inserts 20 raised relative to the surface of the concave features 3. The movable inserts 20 in FIG. 18B are depicted as disposed concentrically with respect to the concave features, but in some embodiments the movable inserts may be more generally disposed non-concentrically with respect to the concave features 3. FIG. 18C illustrates a portion of a mold with movable inserts 22 and sub-inserts 23 produced using the methods described in FIGS. 13-17 with the surface of the movable inserts 22 and sub-inserts 23 raised relative to the surface of the concave features 3. The movable 22 inserts and sub-inserts 23 in FIG. 18C are depicted as disposed concentrically with respect to the concave features 3, but in some embodiments the movable inserts 22 and sub-inserts 23 may be more generally disposed non-concentrically with respect to the concave features 3. FIG. 18D illustrates a portion of a mold with movable inserts 20, 25 produced using the methods described in FIGS. 13-16. Some of the movable inserts 20 in FIG. 18D are disposed concentrically with respect to the concave features 3 and other movable inserts 25 are disposed non-concentrically with respect to the concave features 3. In FIG. 18D, the non-concentric inserts 25 are disposed at the intersection of adjacent concave features and are recessed relative to the surface of the concave features 3.

In summary, embodiments of the present invention described above with reference to FIGS. 1-18 can provide a mold for a plano-convex lens array and a method of production by machining using an end-mill or other machining element. The mold includes an array of features for molding lens elements. The mold further includes sharp, cusp-like boundaries or peaked ridges disposed between adjacent features of the array. A flowable, hardenable polymer material coats the mold to produce an optically-smooth surface. The polymer material is hardened and conforms to the shape of the sharp, cusp-like boundaries or peaked ridges, which point roughly in the opposite direction of the force of gravity. The polymer material smoothes roughness of the machined surfaces in the mold, but does not smooth the sharp, cusp-like boundaries or peaked ridges. In such embodiments, the machining defines to a great extent the shape of the lens elements, and the polymer material defines the smoothness of the lens elements.

Various embodiments based on the embodiments described above become evident and are also included in the scope of the present invention. In some embodiments, the machining using an end-mill includes a plunge cut into the work of an end-mill with a specified spherical or aspherical crown shape that defines the shape of the lens elements. In some embodiments, the polymer coating 6 serves also as a release layer, providing a surface with chemical characteristics such that cured silicone does not adhere strongly to the surface of the coating, thereby facilitating the removal of a finished silicone-on-glass lens 10 from the mold 7.

In further embodiments, the mold 7 described above can include an eject feature 8 to assist the separation of lens arrays from the mold by the injection of a fluid (e.g. air, pressurized air, nitrogen gas, other gases, ethylene glycol, water, or other liquids) between the lens arrays and the mold. The eject feature 8 extends from a surface of one or more of the features 3 of the array to the opposite side of the mold 7. The eject feature 8 includes a movable pin 8a (optionally threaded) that is machined on one side to form at least a portion of one or more features 3 in the mold 7 for molding lens elements. The hardenable polymer material 6 smoothes roughness of the machined surface 3 for the air eject feature 8. The eject feature 8 can alternatively or additionally provide the capability of pushing the movable pin(s) 8a against a finished lens array 10, thereby facilitating the separation of the lens array 10 from the mold 7.

In still further embodiments, the mold 7 may include movable pins outside the concave surfaces of the features 3 that push against the perimeter or an area near the perimeter of a finished lens array 10, thereby separating the lens array 10 from the mold 7.

In yet further embodiments, the features 3 for molding lens elements may include raised or recessed portions such that the mold produces lens arrays with reduced volume, thereby reducing material costs and weight. In particular, such methods of production include additional process steps of forming movable inserts 20 disposed in the mold 7, machining of the mold 7 and inserts 20 together using and end mill such that a continuous concave surface 3 is formed, coating the mold 7 and inserts 20 together with flowable, hardenable polymer 6 to produce an optically-smooth surface, and moving inserts 20 to produce abrupt discontinuities in the concave surface 3, thereby forming the template against which the lens elements are formed by molding. In such embodiments, the mold 7 can be coated with a highly conformal mold release layer, such as parylene, to reduce adhesion between the molded lens array 10 and the mold 7, specifically in the sidewalls of the inserts 20 and/or holes 15 exposed by moving the inserts 20.

The present invention has been described herein with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “in contact with” or “connected to” or “coupled to” another element, it can be directly contacting or connected to or coupled to the other element or intervening elements may be present. In contrast, when an element is referred to as being “in direct contact with” or “directly connected to” or “directly coupled to” another element, there are no intervening elements present.

It will also be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

Furthermore, relative terms, such as “under” or “lower” or “bottom,” and “over” or “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. In other words, the regions illustrated in the figures are schematic in nature and their shapes are not intended to illustrate the actual shape of a region of a device and are not intended to limit the scope of the invention.

Unless otherwise defined, all terms used in disclosing embodiments of the invention, including technical and scientific terms, have the same meaning as commonly understood by one of ordinary skill in the art to which this invention belongs, and are not necessarily limited to the specific definitions known at the time of the present invention being described. Accordingly, these terms can include equivalent terms that are created after such time. It will be further understood that terms, such as those defined in commonly used dictionaries, should be interpreted as having a meaning that is consistent with their meaning in the present specification and in the context of the relevant art and will not be interpreted in an idealized or overly formal sense unless expressly so defined herein. All publications, patent applications, patents, and other references mentioned herein are incorporated by reference in their entireties.

As used herein, “concentrated photovoltaic” describes a system that concentrates electromagnetic radiation/sunlight from the sun to a spot with irradiance greater than about 1000 W/m² in some embodiments, and generates electrical power from the resulting concentrated electromagnetic radiation.

“Solar cell” may refer to a basic photovoltaic device that is used under the illumination of sunlight to produce electrical power. Solar cells contain semiconductors with a band-gap and at least one p-n junction. Compositions of a solar cell may include silicon, germanium, or compound semiconductors such as gallium arsenide (GaAs), aluminum-gallium arsenide (AlGaAs), indium-gallium arsenide (InGaAs), aluminum-gallium-indium-arsenide (AlInGaAs), gallium-indium phosphide (GaInP), aluminum-indium phosphide (AlInP), aluminum-gallium-indium phosphide (AlGaInP), and combinations thereof.

“Receiver” may refer to a group of one or more solar cells and secondary optics that accepts concentrated sunlight and incorporates means for thermal and electric energy transfer.

“Module” may refer to a group of receivers, optics, and other related components, such as interconnection and mounting, which accepts unconcentrated sunlight. The above components are typically prefabricated as one unit, and the focus point may not be field adjustable, A module could be made of several sub-modules. The sub-module is a physically stand-alone, smaller portion of the full-size module.

Many different embodiments have been described herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

Although the invention has been described with reference to particular embodiments, it will be appreciated that variations and modifications may be made within the scope of the principles of the invention. Hence, it is intended that the above embodiments and all of such variations and modifications be included within the scope and spirit of the invention, as defined by the claims that follow.

1. A method of fabricating a lens array, comprising:
forming a mold having a densely-packed array of concave-shaped recesses that have a curvature according to a desired lens profile and cusped ridges between adjacent recesses;
coating the mold with a liquid coating material configured to reduce a surface roughness of the concave-shaped recesses and configured to conform to a shape of the cusped ridges;
hardening the liquid coating material on the mold with a force of gravity pointing opposite the cusped ridges; then
providing a layer of optically transparent silicone in the array of concave-shaped recesses to thereby define an array of plano-convex lenses; and
removing the array of plano-convex lenses from the mold.

2.-16. (canceled)

17. A plano-convex lens array, comprising:
an optically transparent silicone layer defining a two-dimensional array of convex lenses, wherein respective boundaries of adjacent ones of the convex lenses are separated by about 20 microns or less.

18. The lens array of claim 17, wherein the respective boundaries of the adjacent ones of the convex lenses are separated by less than about 12.5 microns.

19. The lens array of claim 17, wherein each of the convex lenses further comprises at least one ring-shaped element concentrically aligned therewith.

20. The lens array of claim 17, wherein the respective boundaries of the adjacent ones of the convex lenses define inverted cusp-like shapes.

21. A method of fabricating a lens array, comprising:
forming a mold having an array of concave-shaped recesses therein and peaked ridges at respective boundaries between adjacent ones of the concave-shaped recesses;
coating the mold with a coating material configured to reduce a surface roughness of the concave-shaped recesses, wherein the coating material conforms to a surface profile of the concave-shaped recesses and the peaked ridges; then
providing a layer of optically transparent material in the array of concave-shaped recesses to thereby define an array of plano-convex lenses; and
removing the array of plano-convex lenses from the mold.

22. The method of claim 21, wherein a distance between the respective boundaries of the adjacent ones of the concave-shaped recesses is about 20 microns or less.

23. The method of claim 21, wherein forming the mold comprises milling a support substrate to define the array of concave-shaped recesses therein and the peaked ridges therebetween; and wherein coating the mold comprises spraying the array of concave-shaped recesses with the coating material.

24. The method of claim 23, wherein the coating material is a hardenable polymer; and wherein spraying with the coating material is followed by curing the coating material to provide an optically smooth surface in the concave-shaped recesses and to define the shape of the peaked ridges in the coating material at the respective boundaries between the adjacent ones of the concave-shaped recesses.

25. The method of claim 24, wherein providing the layer of optically transparent material in the array comprises:
attaching an optically transparent plate to the mold; and then
injecting the optically transparent material into a cavity defined between the optically transparent plate and the cured coating material on the array of concave-shaped recesses.

26. The method of claim 25, wherein the optically transparent material is silicone.

27. The method of claim 26, wherein the optically transparent plate comprises a glass plate having a first surface facing the mold; wherein providing the layer of optically transparent material in the array comprises injecting the silicone into the cavity between the first surface and the cured coating material; and wherein a degree of adhesion between the first surface of the glass plate and the silicone is greater than a degree of adhesion between the silicone and the cured coating material.

28. The method of claim 25, wherein attaching the optically transparent plate is preceded by treating the optically transparent plate to increase an adhesion characteristic of a surface thereof with respect to the optically transparent material.

29. The method of claim 23, wherein milling comprises plunge-cutting the support substrate using an end mill having a cross-section substantially similar in shape to that of a plano-convex lens of the array.

30. The method of claim 21, wherein the mold comprises a support substrate having one or more moveable pins therein extending to a backside of the support substrate; and wherein forming the mold comprises milling the array of concave-shaped recesses into the support substrate including the one or more moveable pins therein.

31. The method of claim 30, wherein said milling comprises milling the one or more pins to define concave-shaped pins adjacent bottoms of the concave-shaped recesses.

32. The method of claim 31, wherein removing the array of plano-convex lenses from the mold comprises pushing the one or more concave-shaped pins toward the array of plano-convex lenses to eject the array from the mold.

33. The method of claim 31, wherein removing the array of plano-convex lenses from the mold comprises moving the one or more pins away from the array of plano-convex lenses and injecting a substance between the layer of optically transparent material and the coating material on the mold through one or more respective channels defined by moving the one or more pins.

34. The method of claim 21, wherein the mold comprises a support substrate having a plurality of movable inserts therein that extend to a backside of the support substrate; wherein forming the mold comprises milling a front side of the support substrate and front sides of the plurality of movable inserts to define the array of concave-shaped recesses having concave-shaped movable inserts adjacent bottoms thereof.

35. The method of claim 34, wherein coating the mold further comprises coating the concave-shaped movable inserts with the coating material; and wherein providing the layer of optically transparent material in the array comprises:
moving the movable inserts including the coating material thereon into or out of the support substrate to thereby raise or recess the front sides of the movable inserts relative to the concave-shaped recesses defining respective discontinuities therebetween; and then
depositing the optically transparent material onto the raised or recessed front sides of the movable inserts.

36. The method of claim 35, wherein providing the layer of optically transparent material in the array is preceded by forming a release layer on exposed sidewalls of the raised or recessed moveable inserts and the support substrate to reduce adhesion between the exposed sidewalls and the optically transparent material.

37. The method of claim 35, wherein the concave-shaped moveable inserts include respective concave-shaped moveable sub-inserts therein; wherein providing the layer of optically transparent material in the array further comprises:
depressing the moveable sub-inserts including the coating material thereon to raise front sides of the moveable sub-inserts relative to the front sides of the moveable inserts; and wherein depositing the optically transparent material further comprises:
depositing the optically transparent material onto the raised front sides of the moveable sub-inserts.

38. The method of claim 34, wherein the plurality of movable inserts are disposed concentrically with respect to the concave-shaped recesses, non-concentrically with respect to the concave-shaped recesses, or some combination thereof.
